(19) United States
(12) Patent Application Publication
(10) Pub. No.: US 2010/0097333 A1
(43) Pub. Date: Apr. 22, 2010

(54) DISTANCE MEASURING DEVICE

(75) Inventor: Uwe Skultety-Betz, Leinfelden-Echterdingen (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/439,085

(22) PCT Filed: Aug. 13, 2007
(86) PCT No.: PCT/EP07/58343

§ 371 Date: Nov. 19, 2009

(30) Foreign Application Priority Data
Sep. 1, 2006 (DE) 102006041078.5

(51) Int. Cl. G06F 3/041

(52) U.S. Cl. 345/173

(57) ABSTRACT

The invention relates to a distance measuring device with a control interface. According to the invention, the control interface has at least one contact-sensitive entry unit.

### TECHNICAL FIELD

The invention is based on a distance measuring device according to the generic term of claim 1.

### BACKGROUND

A distance measuring device for measuring distances is known. It is provided with an entry unit for entering information by an operator, which is construed as control keyboard.

### SUMMARY

The invention is based on a distance measuring device with a control interface.

It is suggested that the control interface provides at least one touch sensitive entry unit. Thereby an especially high operating comfort and a high flexibility in the application of the distance measuring device can be achieved. A “touch sensitive” entry unit means in this context in particular an entry unit, which is construed for an almost depressurized entry. The entry unit can thereby be provided with a touch detector, which can detect a contact, particularly a depressurized contact of a surface of the entry unit for example with the aid of a capacitive sensor. Alternatively or additionally the touch sensitivity of the entry unit can be achieved by a resistance-controlled detection. The entry unit provides thereby preferably at least two conductive layers, which come into contact with each other when touching a surface of the entry unit with a soft pressure, whereby the touch can be detected by the resistance of this contact. A detection of a contact that is based on the principle of a light barrier, in particular a depressurized contact, for example by infrared radiation sources, is also possible. In a further embodiment the entry unit can furthermore be provided for detecting the contact by a detection that is controlled by sound waves, which are for example achieved by the use of piezoelectric elements.

Furthermore the number of elements for the control interface, which are mounted movably in relation to the housing of the distance measuring device, can be advantageously reduced. In particular the use of movable elements can be waived. Thereby a particularly effective shield of an interior of the housing can be achieved against the invasion of dirt and/or liquid over the depository of a movable element. Furthermore a constructively complicated contacting of a set of movable elements can be avoided, whereby installation space on the inside of the housing can be saved. Furthermore a flexible configuration of the interior can be achieved, in particular with regard to the arrangement of a circuit board.

The distance measuring device can be provided with a display unit, whereby the touch sensitive entry unit is separate from the display unit. The entry unit can for example be designed as a touch pad (or integrated touch field), and in combination with the display unit used for operating the distance measuring unit.

A compact configuration of the distance measuring device can be in particular achieved if the touch sensitive entry unit provides a touch area, which is provided by a display unit for displaying information. The entry unit can be arranged for example by a touch screen.

It is furthermore suggested that the control interface is arranged at a control side and that the touch area spreads over at least one essential part of the control side. Thereby a particularly high reading—and operating comfort of the control interface can be achieved. The control side is preferably created by a housing side of the distance measuring device. An “essential” part of the control side can mean in this context in particular at least 40%, advantageously 50% and preferably at least 70% of the control side.

It is furthermore suggested that the distance measuring device provides a control unit, which is provided together with the touch sensitive entry unit for processing distance information by an operator, whereby a high flexibility can be achieved in the application of the distance measuring device. The “distance information” can mean any information, which concerns the characteristics of distances. Distance information can for example mean measurement results of a distance measurement, an assignment of a specific distance to a space that has to be measured or has been measured, an assignment of a distance to an area of a measured space, as for example the assignment of a distance to a certain wall and so on. In this context a processing can for example mean an assignment, an evaluation and so on.

A particularly clear assignment of the distance information can be simply and comfortably achieved if the control unit is provided for creating a chart for assigning the distance information by an operator with the aid of an entry unit.

It is furthermore suggested that the distance measuring unit provides a display unit and a control unit, which is provided together with the touch sensitive entry unit to assign a display field for displaying distance information of a distance to a control function for controlling a measurement of the distance. Thereby a particularly simple controlling of the distance measuring device can be achieved. In particular a complicated navigation in a menu can be avoided. The display field can especially be an area of a display unit of the distance measuring device, whose dimension is adjusted to the display of a parameter, in particular a number and if necessary a unit. The display field can for example be a chart field of a chart for assigning distance information, whereby an assignment of distance information can be particularly fast and simply achieved in the course of a space measurement. A controlling of the measurement can for example mean a starting, a stopping or a repeating of a measurement.

It is suggested in an advantageous improvement of the invention that the distance measuring device comprises a control unit, which provides a draw mode, which is provided for designing a drawing with the aid of the touch sensitive entry unit. Thereby a high comfort and a high flexibility in the application of the distance measuring device can be achieved.

In this context a particularly high and intuitive creation of the drawing can be achieved, if the control unit is provided to create the drawing by sketching it by an operator with the aid of the touch sensitive entry unit.

A particularly comfortable controlling can be achieved, if the distance measuring device provides a control pen for controlling the entry unit.

It is furthermore suggested that the distance measuring device provides a control key, which is designed for controlling together with the touch sensitive entry unit. Thereby a particularly simple controlling of the distance measuring device and an advantageous complementarity with the touch sensitive entry unit can be achieved, especially if the distance measuring device is kept in a position that complicates a controlling of the touch sensitive entry unit.

### BRIEF DESCRIPTION OF THE DRAWINGS

Further advantages arise from the following drawing description. The drawing shows embodiments of the invention. The drawing, the description and the claims contain several characteristics in combination. The expert will consider these characteristics also individually and summarize them to further useful combinations.

It is shown in:

FIG. 1 is a distance measuring device with a touch screen and a control pen,

FIG. 2 shows schematically an illustration of the touch screen from FIG. 1, on which a drawing is sketched with the aid of the control pen,

FIG. 3 shows schematically an illustration of a draw mode, in which a freehand sketch is processed,

FIG. 4 illustrates a draw mode, in which a display field is moved with the aid of the control pen,

FIG. 5 illustrates a draw mode, in which a drawing is adjusted to measurement results,

FIG. 6 illustrates a draw mode, in which a measuring process is started by actuating a symbol,

FIG. 7 illustrates a draw mode, in which a drawing is created by external data,

FIG. 8 illustrates a processing mode, in which a chart with distance information is created,

FIG. 9 shows the connecting of a printing unit to the distance measuring device, and

FIG. 10 is an alternative embodiment of the distance measuring device with a touch screen and a control element.

### DETAILED DESCRIPTION

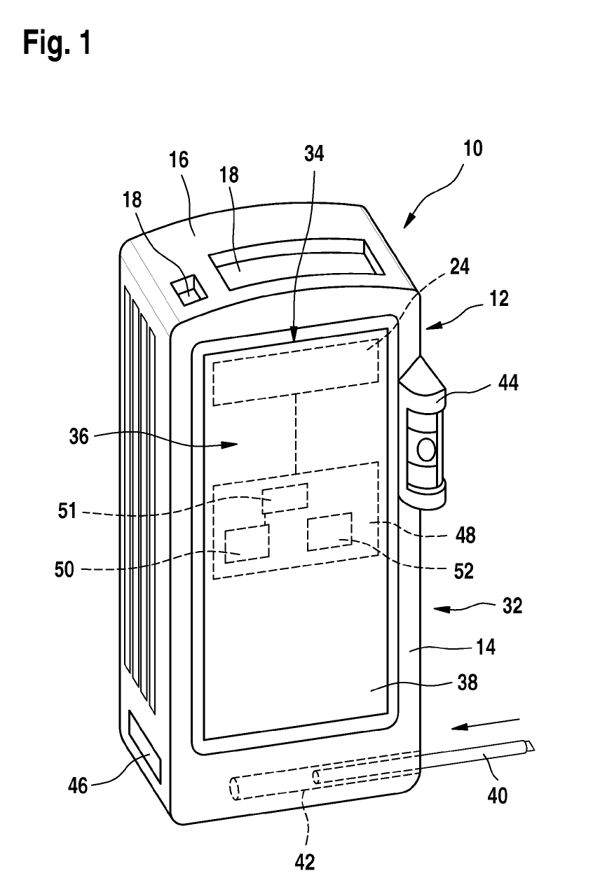

FIG. 1 shows a distance measuring device 10 from a perspective view. The distance measuring device 10 provides a housing 12, which creates a control side 14 and a signal side 16, which boarders at the control side 14. The signal side 16 provides optical components 18, about which an optical measuring signal 20, especially a laser signal, is send or received (see FIG. 5). With the aid of the measuring signal 20 a distance of the distance measuring device 10 to an object 22 that has to be measured can be detected. For creating, receiving and processing the measuring signal 20 the distance measuring device 10 is provided with a measuring unit 24, which has a transmitting unit 26, a receiving unit 28 and an evaluation unit 30 for evaluating the received measuring signal 20 (see FIG. 5).

The control side 14 provides a control interface 32, which is provided for communicating with an operator. The control interface 32 comprises a display unit 34, which is designed as a screen for displaying information. The display unit 34 is designed as a touch screen and creates a touch sensitive entry unit 36. Therefore the display unit 34 provides a transparent screening layer, whose surface creates a touch area 38 of the entry unit 36, which is provided for entering information by touching it. The entry unit 36 is construed in this example for detecting a contact with the aid of a resistance controlled detection. Therefore the entry unit 36 provides a further transparent screening layer (not shown in the figure), which is arranged with a distance to the upper screening layer that creates the touch area below this upper screening layer. The screening layers are conductive and construed as ITO-layers (indium tin oxide). When touching the upper screening layer the screening layers come into electric contact to each other. Due to the resistance of this contact an electric voltage occurs at the contact point, which can be detected with the aid of not shown sensors. The detected voltage change can be used for determining the coordinates of the contact point. The touch area 38 creates a touch area, which is provided for an entry and which spreads advantageously over an essential part of the control side 14, thus over ca. 70% of the control side 14.

For controlling the entry unit 35 the distance measuring device 10 is provided with a control pen 40. Within the housing 12 a holding area 42 for holding the control pen 40 is left out. Thereby a detaching of the control pen 40 from the housing 12 can be avoided when transporting the distance measuring device 10. It is possible in one embodiment that a attaching tool for attaching the control pen 41 is formed at the surface of the housing 12. Furthermore a spirit level 44 is fixed at the housing 12. The distance measuring device 10 also provides a data interface 46, which is construed as Bluetooth interface and which is provided for creating a data connection with an external data unit (see for example FIG. 7).

For implementing control modes of the distance measuring device 10 it is provided with a control unit 48. The control unit 48 comprises a first storage unit 50, in which programs for implementing the control modes of the distance measuring device 10 are saved. The control of the control modes together with the storage unit 50 takes place with the aid of an arithmetic unit 51, which is construed as processor or microcontroller. Furthermore a second storage unit 52, whose function is described further below, is arranged in the control unit 48.

The control unit 48 is especially provided with control modes, which are each provided as draw modes for designing a drawing. These draw modes are explained by the subsequent figures.

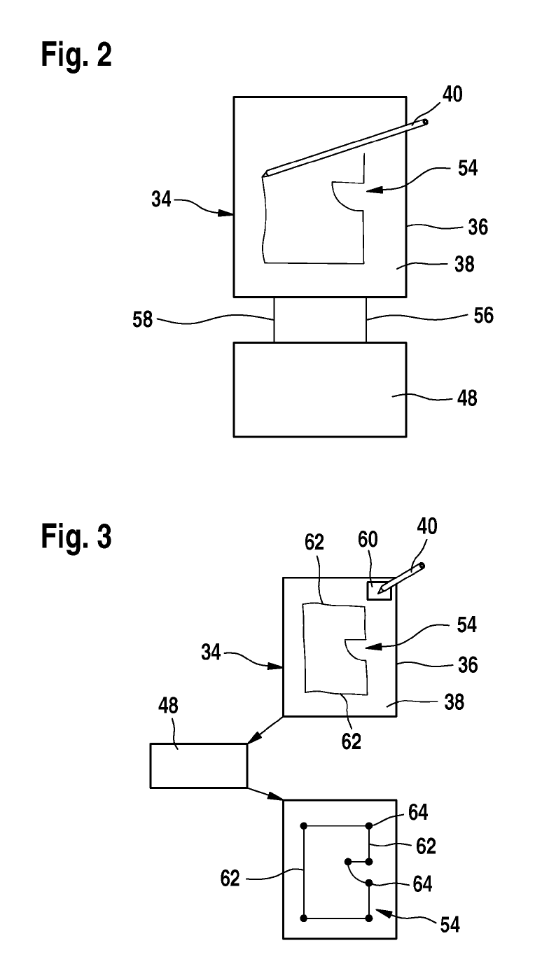

FIG. 2 shows the entry unit 36 and the control unit 48 in a schematic view. It is assumed that an operator undertakes the measurement of a space with the aid of the distance measuring device 10. Prior to the measurement the operator can create a drawing 54 with the aid of the entry unit 36 under the form of a freehand sketch of the space that needs to be measured. Therefore the operator turns on a draw mode of the control unit 48, in which he can move the tip of the control pen 40 on the touch area 38 of the entry unit 36 in order to sketch. The control unit 48 records thereby together with the sensors of the entry unit 36 (not shown in the figures) positions of the control pen 40 on the touch area 38. The control unit 48 creates with these positioning information 56 the drawing 54, which is shown by the display unit 34. Thereby control signals 58 for controlling the display unit 34 by the control unit 48 are detected with the aid of the positioning information 56.

The created freehand sketch can furthermore be processed by the control unit 48 in the draw mode. A processing by the control unit 48 is explained by FIG. 3. The processing is started by the control pen 40 or a finger by marking and/or activating a control field 60, which is shown by the display unit 40. The control unit 48 is provided with a detection function, with which individual distances 62 that create the drawing 54 can be detected. These distances 62 can furthermore be determined by an entry of the operator if he marks the vertices 64 of the drawing 54 with the control pen 40. Once the individual distances 62 are determined a smoothening process and/or an alignment of the distances 62 takes place. Optionally the operator can have influence on the distance processing if he accept or declines suggested solutions and/or if he determines the alignment and/or the length of a distance that has to be processed.

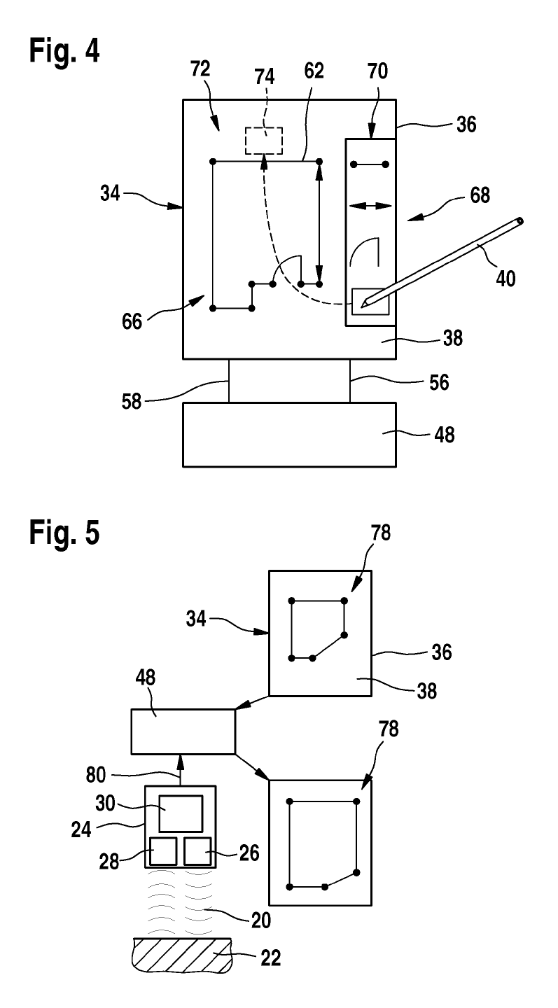

A further draw mode of the control unit 48 is schematically shown in FIG. 4. The operator can create a drawing 66 in this mode by default symbols 68. These are illustrated in a toolbar 70, which is shown on the side of a draw field 72. For creating the drawing 66 a symbol 68 can be marked in the toolbar 70 by the control pen 40 and moved into the draw field 72 in a desired position.

A distance 62 that is determined by the drawing can furthermore be assigned to a display field 74 for displaying a distance information. The operator can therefore mark a symbol 68 that illustrates the display field 74 and place it into a desired position within the drawing field 72 by a movement that is shown by a dotted line in the figure. The display field 74 in the draw field 72 represents an area of the display unit 34, which is provided in this embodiment for displaying the length of the assigned distance 62 after its measurement. Alternatively or additionally an indication that is provided for an assignment of the distance 62 can be shown.

FIG. 5 explains a further draw mode of the control unit 48. It is assumed that an operator has created a drawing 78 of a space that has to be measured, for example with the aid of one of the above described draw modes. Subsequently the operator carries out a measurement of the space with the aid of a measuring mode of the measurement unit 24. Due to the measurement results 80 that have been detected by the measurement unit 24 the control unit 48 is provided to adjust the drawing that has been created prior to the measurement to the measurement results 80, whereby a picture of the measured space is created true to scale by the control unit 48.

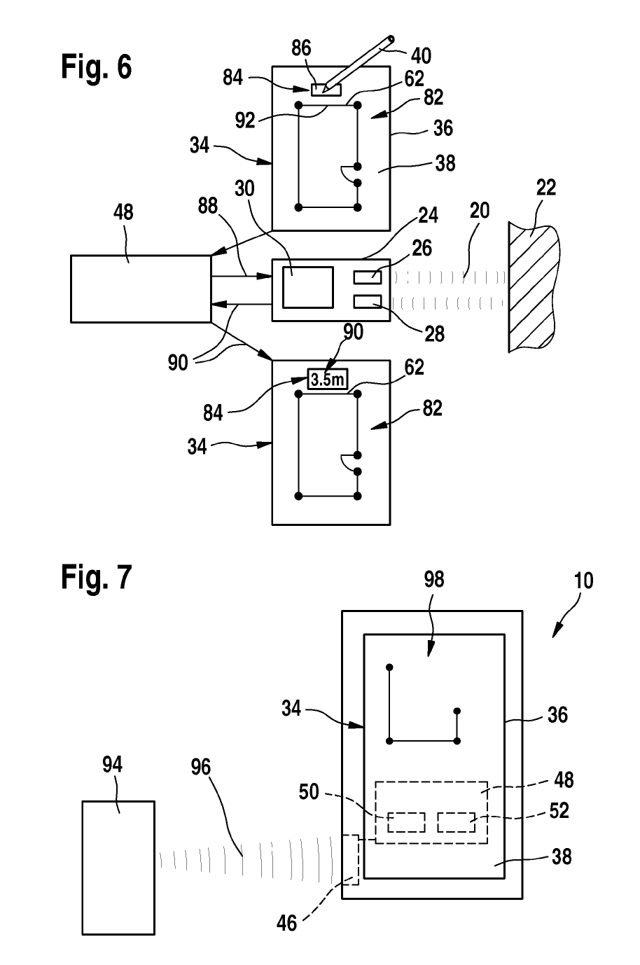

The control unit 48 is provided with a further control mode, which is explained by FIG. 6. It is assumed that the operator has created a drawing 82 of a space that has to be measured for example with the aid of the draw mode shown in FIG. 4, whereby a specific distance 62 of the drawing 82 has been assigned to a display field 84 for displaying a measurement result. It is furthermore assumed that the operator wants to measure the distance 62. In the here described control mode of the control unit 48 the operator can mark and activate the symbol 86 that illustrates the display field 84 by the control pen 40. This activates a control function of the control unit 48, which transmits a control signal 88 for starting a measuring process of the measuring unit 24 to the measuring unit 24, which determines a measurement result 90 with the aid of the measuring signal 20. After the measurement the measurement result 90 is shown in a unit of length in the corresponding display field 84 by the control unit 48 in connection with the display unit 34. In an embodiment of the control mode the operator can directly mark and activate a symbol 92, which is designed as a line and which illustrates the distance 62, whereby the measuring process of the selected distance 62 is started. It is also possible that the operator is asked to start the measuring process for example by a blinking of the symbol 86 and/or the symbol 92.

FIG. 7 shows a further draw mode of the control unit 48. A data connection is created in this draw mode with an external data unit 94, as for example a PDA (personal digital assistant) or a notebook. With the data 96, which is read by the data interface 46, a drawing 98 that corresponds with the data is shown by the control 48 together with the display unit 34. Alternatively or in addition to the display imported data can be saved in the storage unit 52, where they are provided for a later processing. A drawing that has been created by an external unit or a drawing model can be imported over the data interface 46 for example. Furthermore drawings can be saved in the storage unit 52, which have been created by the operator with the aid of the entry unit 36. It is possible in a further embodiment of the distance measuring device 10 that the data interface 46 is construed as scanning unit, over which a drawing, as for example a freehand sketch, can be scanned.

In a further control mode of the control unit 48 a program can furthermore be downloaded over the data interface 46 for implementing the control modes, in particular the draw modes of the control unit 48. Thereby a data connection is created between the data interface 46 and the storage unit 50. Therefore the operator can update present programs and/or the control unit 48 can be provided with enhanced control modes, in particular draw modes.

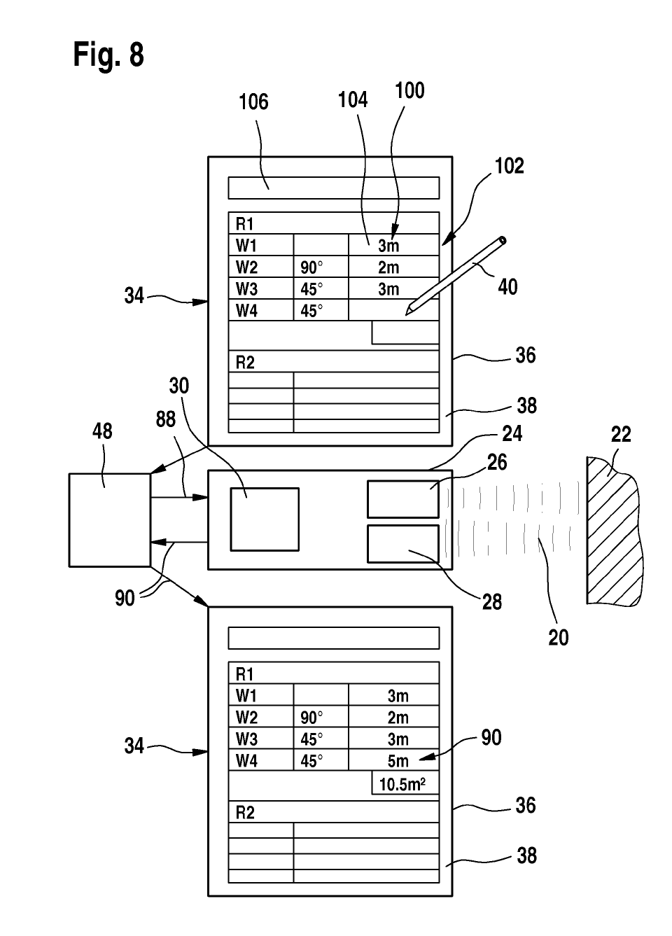

FIG. 8 shows a further operating mode of the control unit 48, in which distance information 100 can be processed with the aid of the entry unit 36. In particular a chart 102 can be created this control mode. In this chart 102 distance information 100 of spaces that have to be measured or have been measured can be registered or evaluated. Sub-charts R1, R2 and so on can be created, which are each assigned to a space. Thereby distance information 100 can be registered in display fields 104 of the sub-charts R1, R2, namely the name of a distance, which corresponds for example with a wall W1, W2 and so on, the detected length of the distance, an angle that is created by two adjoining distances and so on. The controlling takes place with the aid of the control pen 40 and over a tool—and/or menu-bar 106, which is shown above the chart 102.

Furthermore the display field 104 of the chart 102 is assigned in the control mode to a control function for controlling a measuring process of the measuring unit 24. By marking and/or activating a display field 104, which corresponds with a distance that has to be measured, in this example distance W4, a measurement of the distance by the measuring unit 24 can be started. This takes place together with the control unit 48 analogous to the process, which is explained in FIG. 6. After the measurement of the distance the length of the distance is shown in the display field 104 with the aid of the measurement result 90. The chart 102 provides furthermore a computational function, which automatically determines an area or a volume of the corresponding space with the aid of distance lengths and angles if necessary.

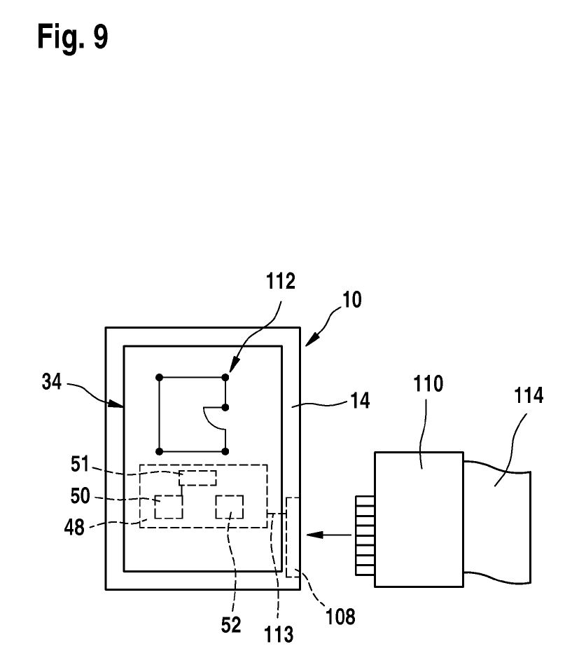

FIG. 9 shows the distance measuring device 10 in a further embodiment. The distance measuring device 10 provides hereby a data interface 108, which is construed for creating a data connection with an external printing unit 110. This printing unit 110, which is designed as a thermo printer, can be fixed at the housing 12 over the data interface 108, which is construed as adapter unit with a mounting interface. The base body of the printing unit 110 is hereby attached at the housing 12. A data connection is created in a printing mode of the control unit 48 between the control unit 48 and the control unit of the printing unit 110, whereby printing data 113 are transmitted by the control unit 48 to the printing unit 110. With the aid of the printing unit 110 a drawing 112, which has been created by the operator and which is saved in the storage unit 52 and/or shown by the display unit 34, can be printed on a medium 114 for drafting a document that concerns a space, for example a protocol.

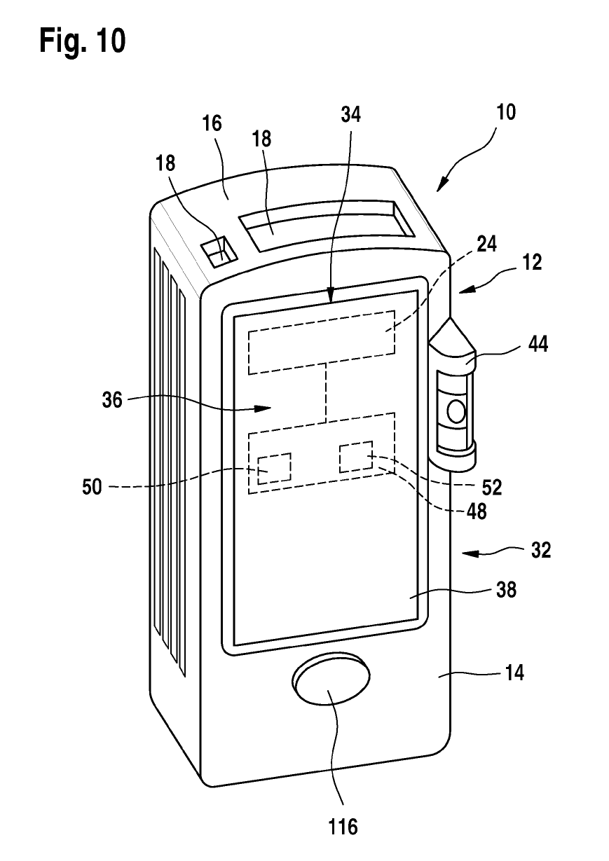

FIG. 10 shows an alternative embodiment of the distance measuring device 10. Thereby no new labels are used for components that correspond with the previous embodiments. The control interface 32 provides in addition to the touch sensitive entry unit 36 a control element 116 that is construed as a control key. This control element 116 is assigned in particular to a control function of the control unit 48 for controlling a measuring process of the measurement unit 24. If the housing 12 is for example held in a position, which makes the controlling of the entry unit 36 by the control pen 40 or a finger difficult, advantageously a starting of a measuring process, in particular in a control mode of the control unit 48 that is described in FIG. 6 or 8, can be for example simply achieved by activating the control element 116.

1-10. (canceled)

11. A distance measuring device, comprising:
a control interface comprising at least one contact-sensitive entry unit.

12. The distance measuring device of claim 11, wherein the at least one contact-sensitive entry unit comprises a touch area, and wherein the touch area is created by a display unit for displaying an information.

13. The distance measuring device of claim 12, wherein the control interface is arranged at a control side, and wherein the touch area spreads out at least over an essential part of the control side.

14. The distance measuring device of claim 11, further comprising a control unit that is configured for processing a distance information by an operator in combination with the at least one contact-sensitive entry unit.

15. The distance measuring device of claim 14, wherein the control unit is further configured for creating a chart for assigning the distance information by an operator with the aid of the at least one contact-sensitive entry unit.

16. The distance measuring device of claim 11, further comprising a display unit and a control unit for assigning a control function for controlling a measurement of a distance to a display field for displaying a distance information.

17. The distance measuring device of claim 11, further comprising a control unit and a draw mode of the control unit for designing a drawing with the aid of at least one contact-sensitive entry unit.

18. The distance measuring device of claim 17, wherein the control unit is configured to create the drawing by sketching by an operator with the aid of the at least one contact-sensitive entry unit.

19. The distance measuring device of claim 11, further comprising an operating pen for operating the at least one contact-sensitive unit.

20. The distance measuring device of claim 11, further comprising an operating element for operating in combination with the at least one contact-sensitive entry unit.
